(19) United States
(12) Patent Application Publication
(10) Pub. No.: US 2024/0276900 A1
(43) Pub. Date: Aug. 22, 2024

(54) Aerator with an Outboard Transmission and Adjustable Depth Control System

(71) Applicant: Metalcraft of Mayville, Inc., Mayville, WI (US)

(72) Inventors: James Hall, Princeton, WI (US); Craig Antonioni, Lomira, WI (US)

(21) Appl. No.: 18/442,879

(22) Filed: Feb. 15, 2024

Related U.S. Application Data
(60) Provisional application No. 63/446,177, filed on Feb. 16, 2023.

(51) Int. Cl. A01B 45/02; A01B 63/00; B60K 17/04; B60K 17/14; B60K 25/02; F16H 47/02

(52) U.S. Cl. CPC A01B 45/02; A01B 63/008; B60K 17/043; B60K 17/14; B60K 25/02; F16H 47/02; B60K 2025/026

(57) ABSTRACT

An aerator implements a drive system with an outboard transmission(s) in which the transmission(s) is arranged outwardly of a frame rail(s) of the aerator's chassis to deliver power to both a drive wheel(s) and a driven set of tines of a tine assembly. The tine assembly may include at least one non-driven or freewheeling set of tines between outer sets of driven tines. An adjustable depth control system allows for selecting a tine depth that can achieved through a single button push that lowers the tine assembly to the selected depth.

### CROSS REFERENCE TO RELATED APPLICATION

This application claims the benefit of U.S. Provisional Application No. 63/446,177 filed Feb. 16, 2023, the subject matter of which is incorporated herein by reference in its entirety.

### FIELD OF THE INVENTION

The invention relates generally to turf maintenance machines and, in particular, to an aerator having drive and depth control systems. Still more particularly, the invention relates to a power transmission that is mounted outboard of the aerator's chassis to transmit torque from the drive system to driven components such as drive wheels and aerator tines and to a system to control the aerator's depth. The invention additionally relates to a method of operating such an aerator.

### BACKGROUND OF THE INVENTION

Aerating lawns or other turf-type ground surfaces is well known. Aeration typically includes forming openings in the ground to create columnar spaces that allow water, air, and nutrients to enter and interact with the soil, below the uppermost ground surface. This procedure improves the accessibility to the water, air, and nutrients for use by the grasses of the lawn or other turf.

Aeration equipment or, more typically, “aerators,” mechanically create openings in the ground by penetrating it with tines. The tines are implemented as a generally cylindrical tine that move up and down, either by reciprocating vertically or by rotating about a horizontal axis. Some tine assemblies have tines that are solid-spikes that merely pierce the ground and push soil material to the side to create the spaces. Other types of tines are hollow tubes that perform coring-type soil removal as plugs while the tine assemblies rotate.

Regardless of the particular configuration(s) of the tine assemblies, aerators are getting more efficient, more powerful, more maneuverable, and more sophisticated. Aerators are increasing in size and operational speed, which can reduce operational time and therefore increase operational efficiency. Besides being more efficient, the larger and faster aerators are more maneuverable than earlier versions. Some aerators have been implemented on zero-turn machine chassis, which improves maneuverability through their zero-turn type turning ability. In addition, tine depth control systems are becoming more sophisticated, permitting precise control of aeration depth, even with varying soil conditions.

However, increasing the speed and maneuverability of aerators presents challenges. Some interactions of the tines with the ground can be undesirable, such as those which substantially disturb the ground surface. Examples of this include tearing or plowing the ground, which may occur if the rotational speed of the tine assembly does not correspond to or match the ground travel speed of the aerator. Mismatched tine assembly operating speed and travel speed can be especially prevalent during rapid accelerations, decelerations, or turning maneuvers. Turning maneuvers create a travel speed differential at different parts of the tine assembly. While turning, an outside portion of the tine assembly must travel along a longer arc and therefore at a greater speed than an inside portion that travels along a shorter arc and therefore a slower speed. These challenges associated with travel speed changes and turning maneuvers can be amplified by the faster and more maneuverable aerators, such as those implemented on zero-turn machine chassis, since speed changes and turning characteristics are more pronounced.

Attempts have been made to reduce tearing or plowing the ground by segmenting the tine assemblies to allow for different rotational speeds of the different tine segments. A known implementation delivers power or drives the inner tine segments and allows the outer tine segments to freewheel. However, the freewheeling outer segments toward the outer arc of a turning maneuver may still create some tearing or plowing. The reason is that the outer segments are traction driven, rotated by their own engagement with the ground. During relatively high-speed and tight cornering maneuvers, it may be difficult for the reactive-rolling or traction driven outer segments to keep up with the adjacent drive wheels, pulling the tines through the turn, which may tear or plow the ground.

Yet other challenges relate to the operational environment and general aeration-task characteristics. Aerating can create a substantial about of loose material or debris, especially core-type aeration. Exposure of the aerator's components to this debris can compromise the integrity and shorten the use-life of the exposed components. Attempts have been made to protect various aerator components from their exposure to debris. An example is an implementation of an ancillary tine housing that provides a hood-like structure as a subassembly that covers the tine assembly and is arranged in a space that is inboard of the aerator's chassis frame rails. Drive chains of this implementation are also mounted inboard of the chassis frame rails, between the frame rails and the tine housing. Although this implementation reduces the drive chains' exposure to debris, confining the drive chains in the gap that is inboard of the chassis frame rails and outside of the tine housing restricts access to them. This access restriction can make drive chain inspection and maintenance tasks challenging.

Accordingly, a need exists to allow for an aerator with a tine arrangement that has outer tine segments that can be forced to rotate at rotational speeds that closely correspond to rotational speeds of their adjacent drive wheels.

A need also exists to provide an aerator with a drive that is both shielded from debris and readily accessible for inspection and servicing.

Aeration presents yet other challenges related to the setting of tine operational depth, usually known as “depth control.” Different aeration depths or tine operational depths can be preferable for different ground, based on differences in soil conditions and turf types. Many aerators have engage-type and disengage-type features to raise the tines out of the ground or lower them into the ground and provide ground-engaging and ground-disengaging states. However, many also require partial disassembly and reconfiguration to provide different maximum operational depths when in the ground-engaging state.

A need therefore also exists to facilitate depth control of an aerator.

### SUMMARY OF THE INVENTION

In accordance with a first aspect of the invention, these needs are met by providing an aerator with a drive system that powers or drives outer tine segments of a tine assembly.

In accordance with another aspect of the invention, these needs are met by providing an aerator with a drive system that includes an outboard transmission(s) that is mounted outwardly of the aerator chassis' frame rail(s).

In accordance with another aspect of the invention, the outboard transmission delivers power to the tine assembly. A pair of outboard transmissions may deliver power for rotating a pair of outer sets of tines at opposite ends of the tine assembly. The transmissions may further deliver power for rotating drive wheels of the aerator.

In accordance with another aspect of the invention, the drive system includes a pair of motor that deliver power into the pair of transmissions. The drive system may be implemented as a hydrostatic drive, with at least one hydraulic pump that pressurizes hydraulic fluid, which is selectively delivered to a pair of hydraulic motors at inputs of the transmissions. The transmissions may include endless transmission devices, such as belts or chain drives. In chain drives, motor sprockets may drive the chains that are connected to driven sprockets that rotate the sets of tines and the drive wheels.

According to another aspect of the invention, transmission covers may be mounted to and extend outwardly from the chassis frame rails. The transmission covers may cover at least portions of the transmissions. Each transmission cover may be segmented, with a rear cover segment and a front cover segment, at least one of which may support a respective drive wheel.

An adjustable depth control system allows for adjusting an aeration depth. A desired aeration depth may be selected and/or changed by manipulating a depth control arm. This may include changing a width dimension of the depth control arm correspondingly changing the depth control arm's range of motion before interacting with a sensor, such as one or more a switch(es), that can interrupt a driving command that is sent to an actuator which vertically moves the tine assembly.

These and other aspects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof.

### BRIEF DESCRIPTION OF THE DRAWINGS

An exemplary embodiment of the invention is illustrated in the accompanying drawings in which like reference numerals represent like parts throughout, and in which:

FIG. 1 is a partially schematic isometric view of an aerator with an outboard transmission(s) and an adjustable tine depth control system in accordance with an aspect of the invention;

FIG. 2 is a top plan view of the aerator of FIG. 1;

FIG. 3 is a top plan view of portions of the aerator of FIG. 1;

FIG. 4 is a partially schematic top plan view of portions of an outboard transmission of the aerator of FIG. 1;

FIG. 5 is an isometric view of an outboard transmission of the aerator of FIG. 1;

FIG. 6 is a cross sectional view of portions of an outboard transmission of the aerator of FIG. 1;

FIG. 7 is a partially schematic isometric view of an adjustable depth control system of the aerator of FIG. 1;

FIG. 8 is a side elevation view of a tine assembly carrier in a lowered position;

FIG. 9 is a side elevation view of a tine assembly carrier in a raised position;

FIG. 10 is a side elevation view of a depth selector with a depth control arm in a narrow-width state;

FIG. 11 is a side elevation view of a depth selector with a depth control arm in an expanded-width state;

FIG. 12 is a side elevation view of a variant of the depth selector of FIG. 10 with a depth control arm in a narrow-width state;

FIG. 13 is a side elevation view of a variant of the depth selector of FIG. 11 with a depth control arm in an expanded-width state;

FIG. 14 is schematic side elevation of the adjustable depth control system with a depth control arm in a narrow-width state and the tine assembly in a fully raised state;

FIG. 15 is schematic side elevation of the adjustable depth control system of FIG. 14 with the tine assembly in a fully lowered state;

FIG. 16 is schematic side elevation of the adjustable depth control system of FIG. 14 with a depth control arm in an expanded-width state and the tine assembly in a fully raised state;

FIG. 17 is schematic side elevation of the adjustable depth control system of FIG. 16 with the tine assembly in a restricted fully lowered state;

FIG. 18 is schematic side elevation of the adjustable depth control system with another depth control arm in a narrow-width state and the tine assembly in a fully raised state;

FIG. 19 is schematic side elevation of the adjustable depth control system of FIG. 18 with the tine assembly in a fully lowered state;

FIG. 20 is schematic side elevation of the adjustable depth control system of FIG. 18 with a depth control arm in an expanded-width state and the tine assembly in a fully raised state; and

FIG. 21 is schematic side elevation of the adjustable depth control system of FIG. 20 with the tine assembly in a restricted fully lowered state.

### DETAILED DESCRIPTION

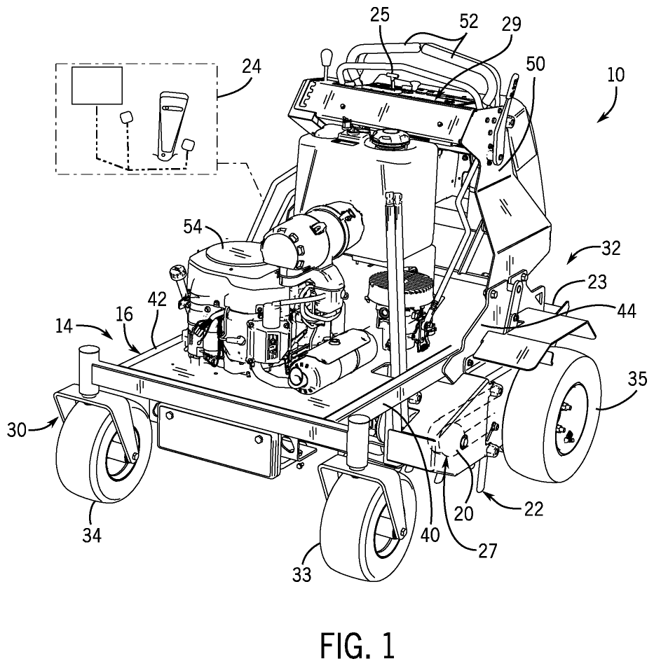

Referring now to the drawings and initially to FIG. 1, in accordance with an aspect of the invention, an aerator machine or aerator 10 is shown that includes a chassis 14 with a frame 16 that supports the various systems, subsystems, and components of aerator 10. Examples of aerator's 10 systems, subsystems, and component that are supported by frame 16 include a drive system 20, a tine assembly 22 that engages with the ground to aerate it, and an adjustable depth control system 24 that is configured to change how the tine assembly 22 interacts with the ground. A tine drive control system 27 controls various operational characteristics of the tine assembly 22, including engagement/disengagement or driving aspects. The illustrated aerator 10 is a “stand-on aerator” controlled by an operator standing on a platform 23 positioned at the rear of the aerator 10. However, the tine assembly drive system and tine depth control system described herein are also applicable to “ride-on” aerators having a seat for supporting a seated operator, and “walk-behind” aerators controlled by an operator walking behind the machine. The aerator 10 also includes various controls such as a throttle control lever 25, shown here mounted on instrument panel 29, for controlling engine speed and the speed of other components or systems that vary as a function of engine speed. Steering control levers 52 control the machine steering and propulsion speed, as described in more detail below.

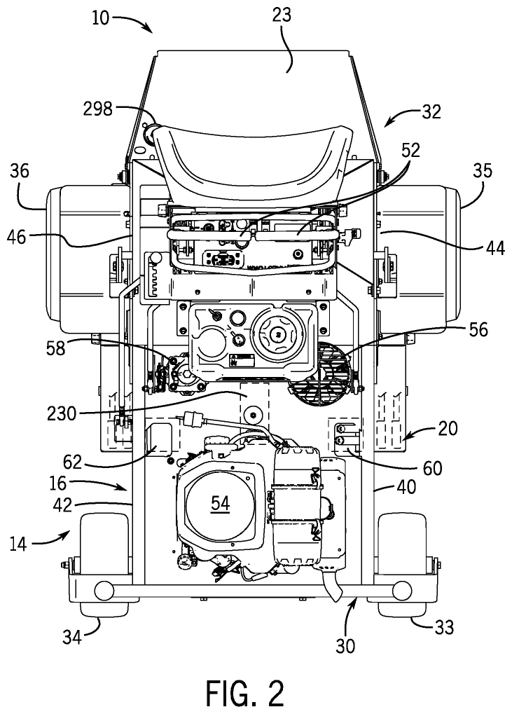

Still referring to FIG. 1, frame 16 includes a front section 30 and a back section 32. A pair of undriven casters 33, 34 are pivotally attached to the front section 30 of frame 16. The front section 30 includes a pair of supports or frame rails 40, 42 that are laterally spaced from each other. The distance between the frame rails 40, 42 corresponds to or generally defines a width dimension of frame 16 and chassis 14. The frame rails 40, 42 and various other components of the frame's 16 front section 30 are typically implemented as hollow tubes. A pair of driven wheels 35, 36 (FIG. 2) is mounted to the frame's back section 32. The back section 32 includes a pair of side plates, only one visible here as side plates 44, 46 (FIG. 2) that extends rearwardly from the frame rails 40, 42. Side plates 44, 46 (FIG. 2) are typically implemented as plate or sheet material. Other plates or sheets of the back section 32 may extend between and interconnect the side plates 44, 46, various ones of which are connected to components of the front section 30. Typically, the various components of the front and back sections 30, 32 are joined together to form a single weldment or unit that defines the frame 16.

Still referring to FIG. 1, an upright handlebar support(s) 50 is mounted to the frame's back section 32. Steering control levers 52 are mounted to the handlebar support(s) 50 and may be moveable forward and back, such as between references bars (not labeled) to provide the steering/propel input to the aerator 10 from the operator during use. Manipulating the steering control levers 52 provides steering control and propulsion speed control. Moving the control levers 52 away from neutral positions by greater distances provides greater propulsion speeds. Steering is effectuated by moving left and right control levers 52 by different distances from their neutral positions with respect to each other or in different directions.

Referring now to FIG. 2, engine 54 delivers power to a hydraulic system with at least one hydraulic pump. The hydraulic system typically includes a pair of variable flow hydraulic pumps 56, 58, which may be axial-piston-type pumps with internal tilting swash plates. The hydraulic pumps 56, 58 provide hydraulic pressure to drive a pair of hydraulic drive motors 60, 62 that connect to and drive associated drive wheel 64, 66 and segments of the tine assembly 22 (FIG. 1).

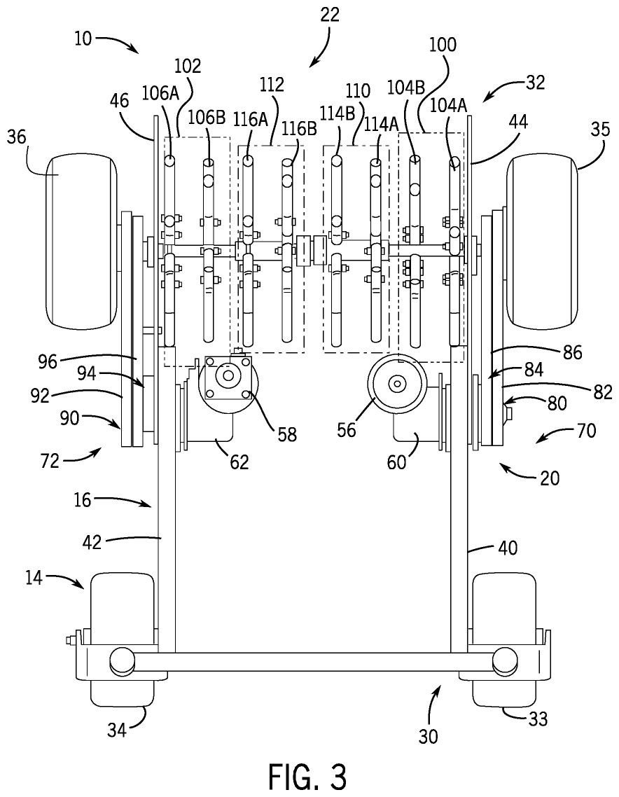

Referring now to FIG. 3, at the left and right sides of the aerator 10, drives or transmissions 70, 72 of drive system 20 transmit power from the drive motors 60, 62 to the drive wheels 64, 66 and tine assembly 22. Each of the transmissions 70, 72 is arranged outboard of the frame 16 or transversely or laterally outwardly of the frame rails 40, 42. The transmissions 70, 72 may incorporate endless transmission devices such as belts or, more typically, chains. Transmission 70 includes chain drive 80 with chain 82 that delivers power to drive wheel 35. Chain drive 84 with chain 86 delivers power to tine assembly 22 at the left side of aerator 10 (right side of the top plan view in FIG. 3). Transmission 72 includes chain drive 90 with chain 92 that delivers power to drive wheel 36. Chain drive 94 with chain 96 delivers power to tine assembly 22 at the right side of aerator 10 (left side of the top plan view in FIG. 3). It is understood that although the motors 60, 62 are shown directly driving the respective drives chain drives 80, 90, the power transmitted from motors 60, 62 may be selectively delivered downstream of the motors 60, 62. In one example, selective tine driving may be implemented by clutches mounted within the tine drive control system 27 (FIG. 1) between the motors 60, 62 and respective segments of tines of the tine assembly 22.

Still referring to FIG. 3, tine assembly 22 has multiple segments, shown with a pair of outer tine segments 100, 102 and a pair of inner tine segments 110, 112. The outer tines segments 100, 102 are powered or driven to rotate by chains 86, 96, respectively. Each of the outer tine segments 100, 102 may have more than one set of tines. Outer tine segment 100 is shown with first and second sets of tines 104A, 104B. Outer tine segment 102 is shown with first and second sets of tines 106A, 106B. The inner tines segments 110, 112 are non-powered or configured to freewheel with respect to the driven outer tine segments 100, 102. Like outer tines segments 100, 102, each of the inner tine segments 110, 112 may have more than one set of tines. Inner tine segment 110 is shown with first and second sets of tines 114A, 114B. Inner tine segment 112 is shown with first and second sets of tines 116A, 116B.

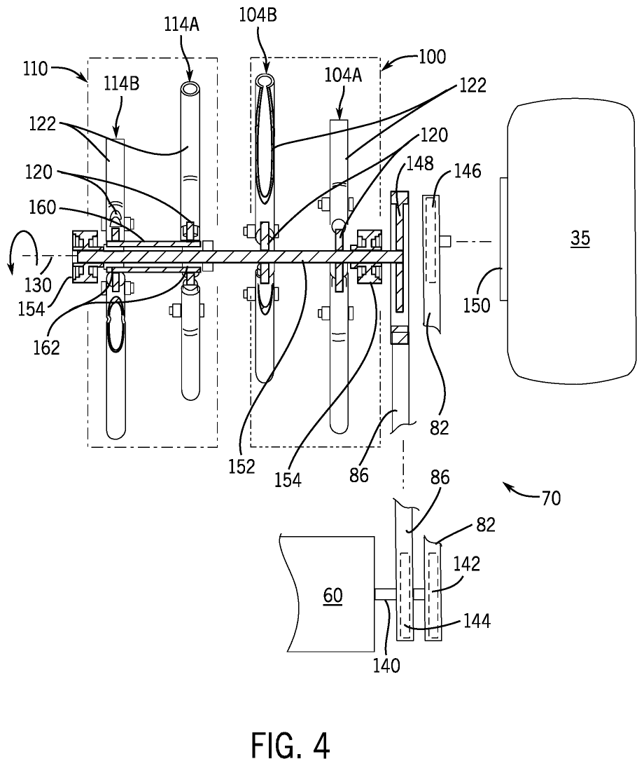

Referring now to FIG. 4, one-half of the tine assembly 22 is shown as the tine assembly's 22 outer and inner tine segments 100, 110. The outer and inner tine segments 102, 112 (FIG. 3) that are not shown are mirror images of outer and inner tine segments 100, 110. Accordingly, the descriptions of outer and inner tine segments 100, 110 also apply to the corresponding components of outer and inner tine segments 102, 112. The same applies to other systems and components of aerator 10, which are substantially mirror images of each other as reflected about a centerline of aerator 10.

Still referring to FIG. 4, each set of tines 104A, 104B, 114A, 114B includes a central hub 120. A number of circumferentially spaced tines 122 are mounted to the hub 120 and extend generally radially away from the hub 120. Tines 122 are shown here configured for core-type aeration, and thus take the form of hollow tubes that can receive a plug of soil from the ground that they engage. It is understood that tines 122 may instead be implemented with other configurations, such as solid spikes. Regardless, the sets of tines 104A, 104B, 114A, 114B are aligned with each other so that they rotate about a common axis of rotation 130. The outer pair of driven sets of tines 104A, 104B rotate in unison with each other, as driven by transmission 70's chain 86. The inner pair of undriven sets of tines 114A, 114B rotate in unison with each other. However, the undriven sets of tines 114A, 114B rotate independently of any driving force from transmission 70. Instead, the undriven sets of tines 114A, 114B are traction driven by their engagement with the ground as the aerator 10 (FIG. 1) travels across the ground. It is also understood that various sets of tines may be configured for reciprocal movement for engaging the ground instead of rotation, for example, by implementing crankshaft-type drive components that convert rotational movement into generally linear reciprocating movements of the tines.

Still referring to FIG. 4, at an input end of transmission 70, drive motor 60 includes output shaft 140 and a pair of motor sprockets 142, 144. The motor sprockets 142, 144 respectively drive the chains 82, 86 in unison with each other. Correspondingly, rotation of drive motor's 60 output shaft 140 also drives rotation of drive wheel 35 (FIG. 3) and outer tine segment 100 in unison with each other. At an output end of transmission 70, driven sprockets 146, 148 are driven to rotate by chains 82, 86. Driven sprocket 146 is connected to wheel hub 150, to which drive wheel 35 is mounted. Transmission 70 converts rotation of the motor's 60 output shaft 140 into rotation of drive wheel 35 through a power transmission path that flows through the interacting motor sprocket 142, drive chain 82, driven sprocket 146, wheel hub 150, and drive wheel 35.

Still referring to FIG. 4, also at the output end of transmission 70, driven sprocket 148 is mounted to shaft 152 that supports the outer and inner tine segments 100, 110. Shaft 152 is supported at its ends by bearings 154. The outer, driven, sets of tines 104A, 104B are mounted in rotational unison onto shaft 152. This may be done by way of set screws, splines, or the like. In this arrangement, transmission 70 converts rotation of the motor's 60 output shaft 140 into rotation of the driven sets of tines 104A, 104B through a power transmission path that flows through the interacting motor sprocket 144, drive chain 86, driven sprocket 148, shaft 152, central hubs 120, and tines 122 of the driven sets of tines 104A, 104B.

Still referring to FIG. 4, although the inner tine segment's 110 undriven sets of tines 114A, 114B are concentrically supported by the shaft 152, they are not locked into rotational unison with the shaft 152. The central hubs 120 of the undriven sets of tines 114A, 114B are mounted to a collar 160, which locks the undriven sets of tines 114A, 114B into rotational unison with each other. Bearings 162 provide a mounting interface between an outer circumferential surface of shaft 152 and an inner circumferential surface of the collar 160. This arrangement allows the shaft 152 and the inner tine segment's 110 undriven sets of tines 114A, 114B to be freely rotatable with respect to each other, allowing the sets of tines 114A, 114B to freewheel with respect to the driven sets of tines 104A, 104B.

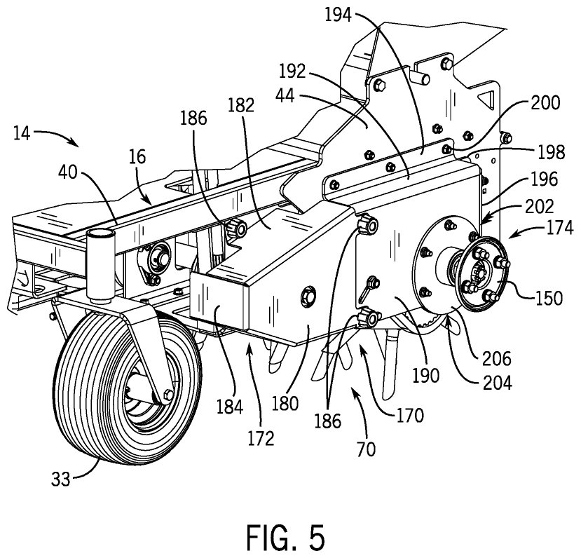

Referring now to FIG. 5, transmission 70 is covered by a transmission cover 170 positioned outwardly of the frame's 16 frame rail 40 and side plate 44. Transmission cover 170 is shown here with a segmented configuration, including front cover section 172 and rear cover section 174. Front cover section 172 has a side wall 180 that is spaced from the frame 16. The front cover section's 172 side wall 180 is upright or arranged generally vertical, extending outwardly beyond and spaced from the frame rail 40. A top wall 182 extends perpendicularly between side wall 180 and frame rail 40 and is shown here angling down from the front cover section's 172 back end toward its front end. At the front end of front cover section 172, an upright or generally vertical front wall 184 connects respective edges of the side and top walls 180, 182. Fasteners, shown here as thumb screws 186, connect the front cover section 172 to the frame 16.

Still referring to FIG. 5, rear cover section 174 has a side wall 190 that is spaced from the frame 16. The rear cover section's side wall 190 is aligned and generally coplanar with the front cover section's side wall 180. Side wall 190 is arranged outwardly beyond and spaced from the side plate 44. Top wall 192 extends perpendicularly between side wall 190 and side plate 44. Flange 194 extends upwardly from an inner edge of top wall 192 and abuts the side plate 44 in a face-to-face engagement. At the back end of rear cover section 174, an upright or generally vertical back wall 196 connects respective edges of the side and top walls 190, 192. Fasteners, shown here as bolts 200, connect the rear cover section 174 to the frame's 16 side plate 44 at the flanges 194, 198. A wheel support 202 includes a base 204 with a flange 206 that abuts an outwardly facing surface of the rear cover section's 174 side wall 190.

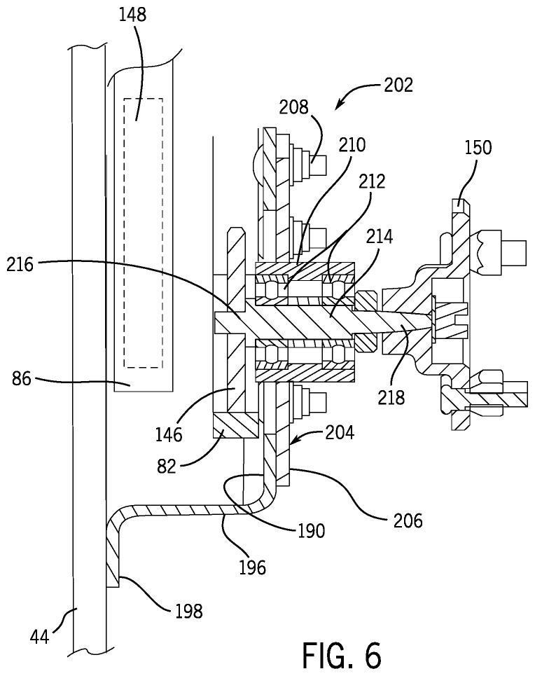

Referring now to FIG. 6, fasteners shown here as bolts 208 connect the base's 204 flange 206 to the rear cover section's 174 side wall 190. A collar 210 extends axially away from the base 204 and houses a pair of bearings 212 that support a wheel shaft 214. Driven sprocket 146 is mounted to an inner end 216 of wheel shaft 214 such as, for example, by way of a splined connection or a welded connection. Wheel hub 150 is mounted to an outer end 218 of wheel shaft 216, shown here with a tapered press-fit connection.

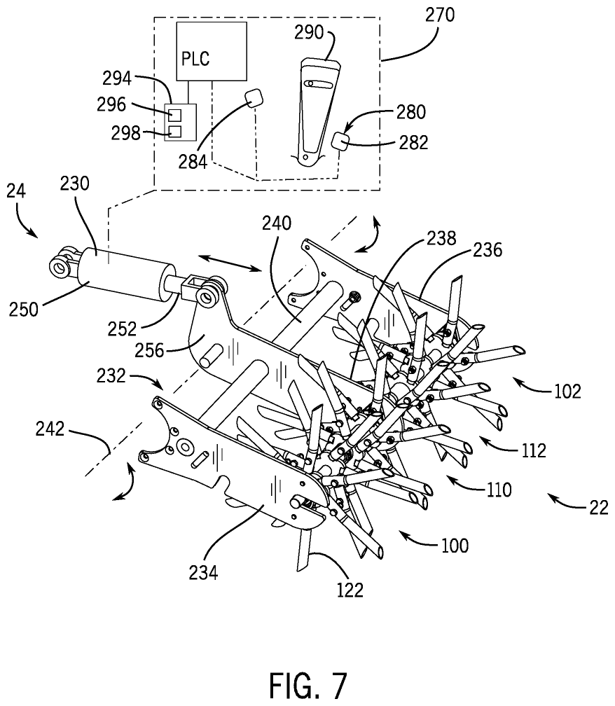

Referring now to FIG. 7, adjustable depth control system 24 includes an actuator, shown as a hydraulic cylinder 230. An assembly carrier 232 provides a moveable structure to which the tine assembly 22 is mounted. Actuating the cylinder 230 moves the tine assembly carrier 232, which changes the height of tine assembly 22 with respect to the ground and the frame 16. Tine assembly carrier 232 includes outer carrier arms 234, 236 and a central main carrier arm 238. The pairs of outer and inner tine segments 100, 110 are mounted between the outer carrier arm 234 and main carrier arm 238 at a left side of the tine assembly carrier 232. At the right side of the tine assembly carrier 232, the pairs of outer and inner tine segments 102, 112 are mounted between the outer carrier arm 236 and main carrier arm 238. Connecting rod 240 extends perpendicularly through and connects the outer carrier arms 234, 236 to the main carrier arm 238. The connecting rod 240 is positioned at a location that is forward of the tine assembly 22 and rearward of a pivot axis 242, about which the tine assembly carrier 232 pivots to change the height of the tine assembly 22 with respect to frame 16 (FIG. 1) and therefore the operational depth of the aerator 10 (FIG. 1).

Still referring to FIG. 7, hydraulic cylinder 230 is typically a double acting cylinder that is mounted along a center line of aerator 10 (FIG. 2). A first fixed end or barrel 250 of the cylinder 230 is connected to the aerator's frame 16 (FIG. 1). A second movable end or rod 252 of the cylinder is connected to an upwardly extending lobe 256 of the main carrier arm 238. Extending the rod 252 pushes lobe 256 further from the barrel 250, which forces the tine assembly carrier 232 to pivot downwardly about pivot axis 242 and increase the depth at which the tines 122 penetrate the ground.

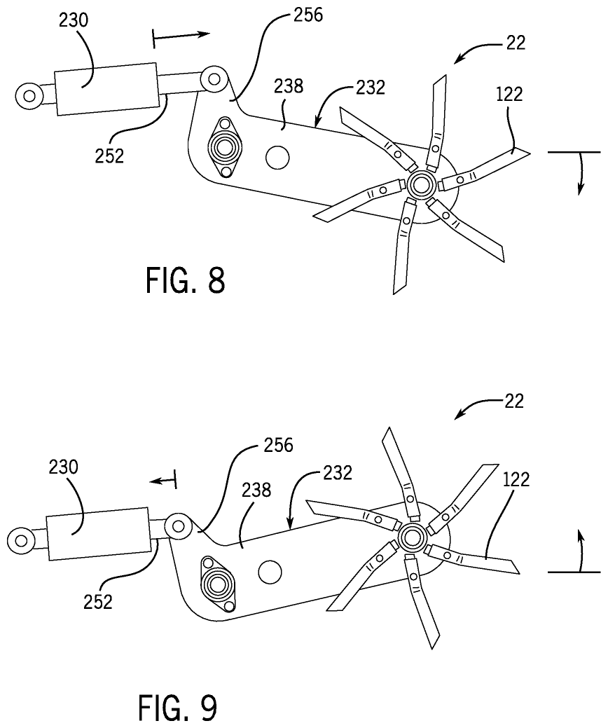

Still referring to FIG. 7, control system 270 controls the aerator's 10 components and systems, such as those of the adjustable depth control system 24 and tine drive control system 27. Within the adjustable depth control system 24, control system 270 controls the movement of the cylinder's rod 252 and corresponding the movement of the tine assembly carrier 232. Control system 270 is typically implemented as a system of control circuits with corresponding relays, switches, sensors, and/or other machine control components. In some implementations, the control system 270 may include a PLC (programmable logic controller), or a microcontroller or other computer that executes various stored programs while receiving inputs from and sending commands to the subsystems of or components of the hydraulic system. A hydraulic valve assembly (not shown) is controlled by the control system 270 to control fluid flow to and from the hydraulic cylinder 230 to control the direction and amount of rod 252 movement for adjusting the height of tine assembly carrier 232. FIG. 8 represents a lowered position in which rod 252 has been extended and the tine assembly carrier 232 has pivoted downwardly. FIG. 9 represents a raised position in which rod 252 has been retracted and the tine assembly carrier 232 has pivoted upwardly.

Referring again to FIG. 7, a sensor assembly is shown for detecting the position of the tine carrier assembly 232, at least in key positions which, in the present case, include a full-up or stowed position, which may be fixed, and an operative position, which may be variable. Any of a number of optical or mechanical sensors or detectors could work for this purpose. In the present embodiment, the sensor assembly takes the form of a switch assembly 280, shown with two switches such as up-stop switch 282 and down-stop switch 284. The-up stop switch 282 detects movement of the tine-carrier assembly 232 into its full-up or stowed position. The down-stop switch 242 detects movement of the tine-carrier assembly into its operative position. A depth selector 290 cooperates with the switch 294 and the control system 270 to set the coring depth of the tine assembly 22. An HMI (human machine interface) 294, shown here including input switches or buttons, such as up and down buttons 296, 298, that allow an operator to input corresponding raise and lower commands to through the control system 270. The HMI 294 or its interface devices are mounted to aerator 10 (FIG. 1) at locations that are easily seen and/or accessed and manipulated by the operator, such as instrument panel 29 and/or platform 23 (FIG. 1). An up command through up button 296 can command the cylinder 230 to drive the tine assembly carrier 232 upwardly unto the depth selector 290 contacts the up-stop switch 282, resulting in actuation of the valve assembly to lock the cylinder 230 in position. A down command through down button 298 can command the cylinder 230 to drive the tine assembly carrier 232 downwardly until depth selector 290 contacts the down-stop switch 284, resulting in actuation of the valve assembly to lock the cylinder 230 in position. Although the up and down buttons 296, 298 are schematically shown here mounted near each other within the HMI 294, it is understood that the up and down buttons 296, 298 may be provided as different sets of buttons in different locations on the aerator 10 (FIG. 1) or otherwise spaced from each other within the same set. An example of this can be seen in FIG. 2 in which the down button 298 is shown implemented as a foot-switch or foot actuated button that is mounted on platform 23.

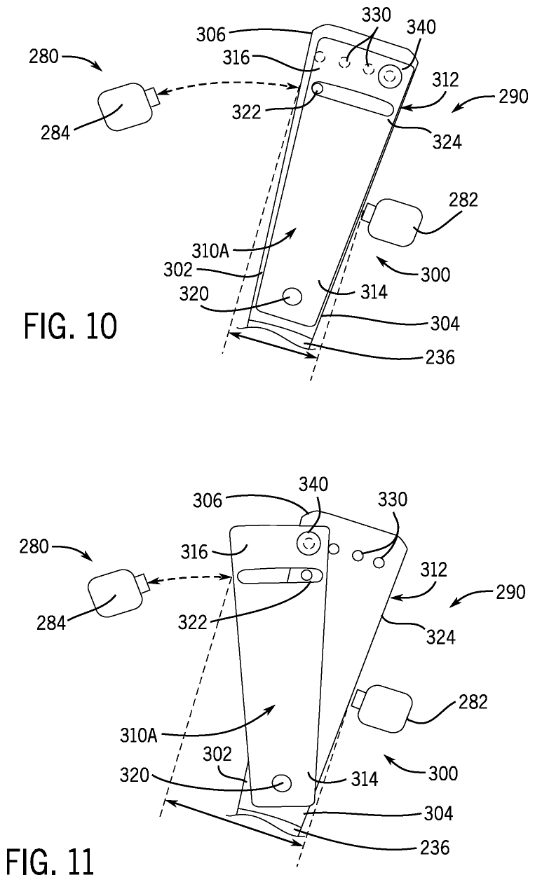

Referring now to FIGS. 10-11, each of the up-stop and down-stop switches 282, 284 is shown as a plunger style switch, although it is understood that optical or other presence or proximity sensors may be used. Depth selector 290 includes a depth control arm 300 is configured to move in coordination with the tine assembly carrier 232 (FIG. 7) so that a position of the tine assembly carrier 232 correlates to a position of the depth control arm 300. This may be achieved by mounting the depth control arm 300 to tine assembly carrier 232 (FIG. 7) so that they move in unison with each other. Typically, the depth control arm 300 is mounted to one of the outer carrier arms 234, 236 (FIG. 7), in alignment with the pivot axis 242 so that the depth control arm 300 and tine assembly carrier 232 (FIG. 7) pivot about the same pivot axis 242. Depth control arm 300 is configured to be adjustable to provide a variable width dimension, measured between respective surfaces that contact the up-stop and down-stop switches 282, 284. When in a narrower or reduced-width state, such as that shown in FIG. 10, the depth control arm 300 must travel a longer swept distance from the up-stop switch 282 to contact the down-stop switch 284. This corresponds to a greater operational depth of aerator 10. When it is in a wider or expanded-width state, such as that shown in FIG. 11, the depth control arm 300 must travel a shorter swept distance from the up-stop switch 282 to contact the down-stop switch 284. This corresponds to a shallower operational depth of aerator 10.

Still referring to FIGS. 10-11, depth control arm 300 includes arm base 302 that has an upright plate-like body with a lower end 304 that is connected to the outer carrier arm 236 and an outer end 306 that is spaced from the carrier arm 236. Adjuster 310A is a pivot-type adjuster that is movably mounted to arm base 302, with a guide system 312 guiding movement between the adjuster 310A and arm base 302. Adjuster 310A also has a plate-like body, shown with a similar profile shape, but smaller than the arm base 302. The adjuster 310A is pivotally mounted in face-to-face engagement with arm base 302. Lower and outer ends 314, 316 of adjuster 310A align over the lower and outer ends 304, 306 of arm base 302. A guide pin, shown as pivot pin 320 of guide system 312, provides the pivot attachment of the arm base 302 and adjuster 310A to each other at their lower ends 304, 314. Another guide pin, shown as slot pin 322, extends through a slot 324 which is formed through the outer end 316 of adjuster 310A. Position lock holes 330 extend through the outer end 316 of arm base 302. Lock pin 340, which is typically a spring-loaded locking pin, is mounted to the outer end 316 of adjuster 310A. The lock pin 340 extends through the back of adjuster 310A to extend into a selected one of the position lock holes 330, to hold the adjuster 310A in a corresponding indexed position relative to the arm base 302 and establish a corresponding width dimension of the depth control arm 300. The number and positions of lock holes 330 correspond to an amount of variable depth adjustability of the aerator 10. The number and positions of lock holes 330 typically allow for depth adjustments of between 1 inch and 6 inches of depth, with increments of one inch or less. More typically, the number and positions of lock holes 330 define an adjustability of between 1-inch depth to 4-inches of depth in one-half inch increments.

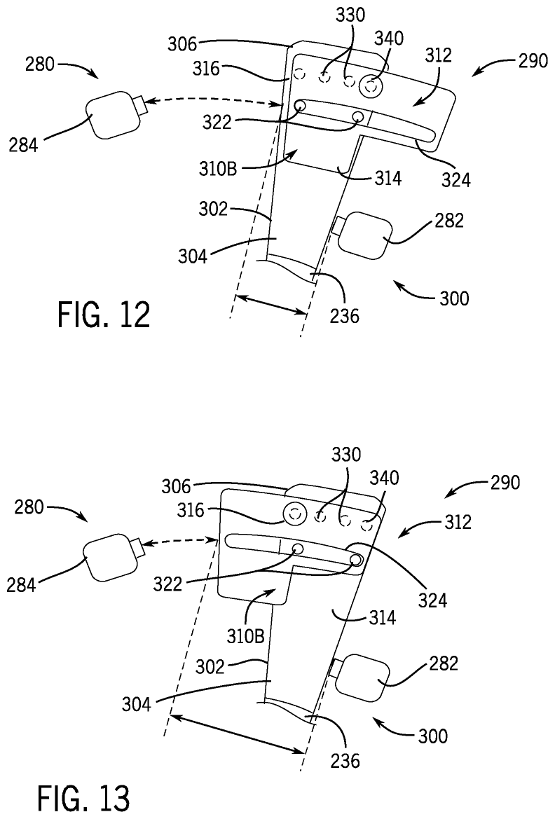

Referring now to FIGS. 12 and 13, in this implementation, the adjuster 310B is a slide-type adjuster that is shorter than that shown in FIGS. 10 and 11 and is not pivot connected to arm base 302. Instead, the guides are implemented as a pair of slot pins 322, which restrict movement of the adjuster 310B to primarily side-to-side translation relative to the arm base 302 through the interaction of the slot pins 322 and slot 324.

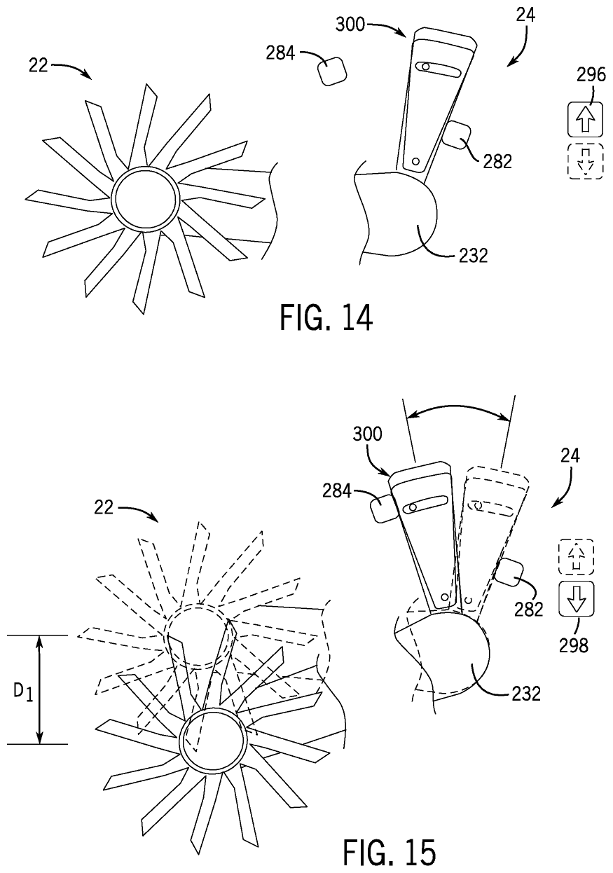

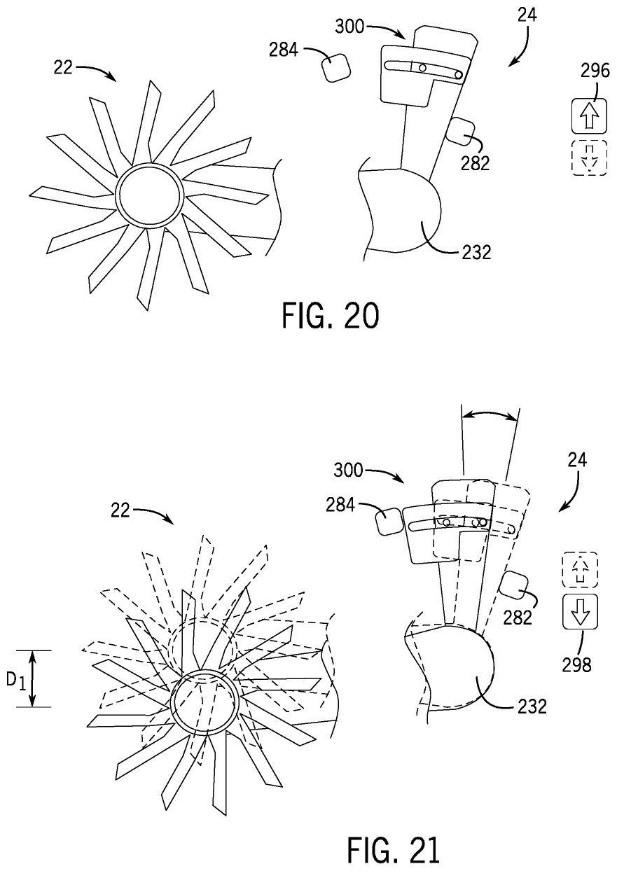

Referring generally to FIGS. 14-21, different ranges of motion of the depth control arm 300 and corresponding different operational depths of tine assembly 22 are shown. Referring more specifically to FIGS. 14-15, in FIG. 14, tine assembly 22 is shown in a default fully raised position. The depth control arm 300 implements the pivot-type adjuster 310A from FIGS. 10-11. In FIGS. 14-15, depth control arm 300 is its narrowest state, allowing the deepest penetration of the ground by tine assembly 22. This position may be achieved by pushing the up button 296 to lift the tine assembly 22 by pivoting the tine assembly carrier 232 upwardly until the depth control arm 300 contacts the up-stop switch 282. From the fully raised position of FIG. 14, as shown in FIG. 15, down button 298 may be pushed to lower the tine assembly 22 by pivoting the tine assembly carrier 232 downwardly until the depth control arm 300 contacts the down-stop switch 282. The distance D1 represents the vertical distance that the tine assembly 22 moved downwardly to achieve its maximum depth when the adjustable depth control system 24 is in its maximum-depth state.

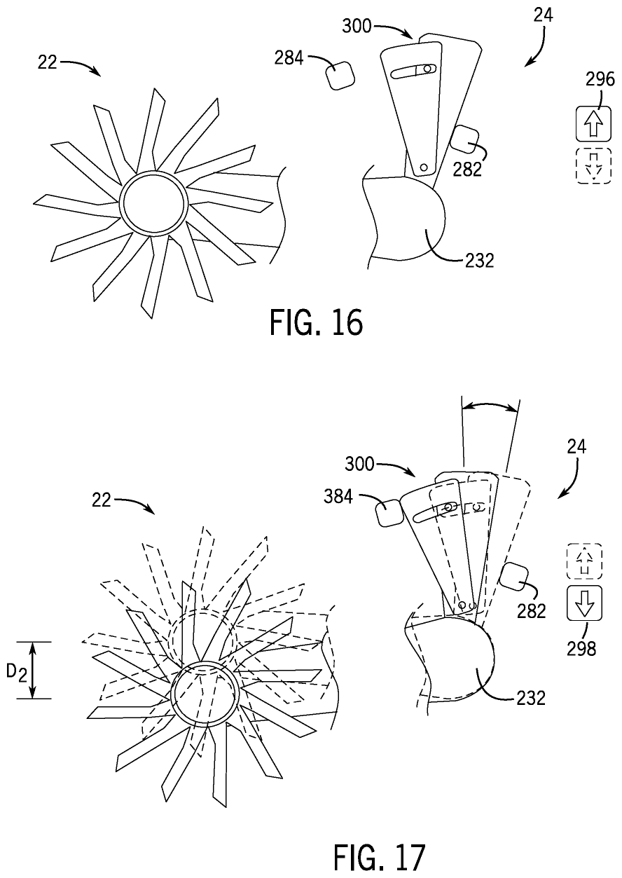

Referring now to FIGS. 16-17, the positions of the tine assembly 22, tine assembly carrier 232, and depth control arm 300 correspond to those shown in FIGS. 14-15. However, in FIGS. 16-17, the depth control arm 300 is in its widest state, restricting the tine assembly 22 to its shallowest penetration of the ground by tine assembly 22. Correspondingly, the distance D2 represents the vertical distance that the tine assembly 22 moved downwardly to achieve its restricted maximum depth when the adjustable depth control system 24 is in its minimum-depth state.

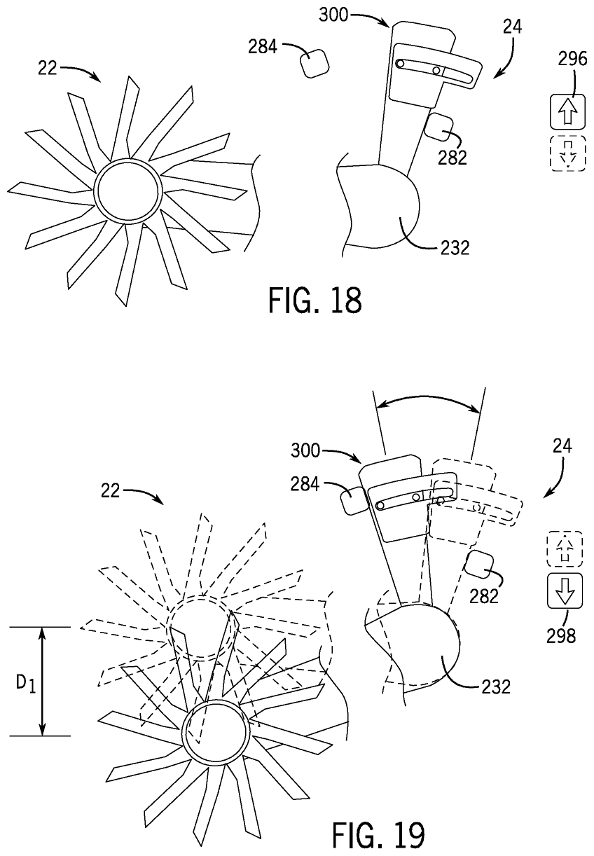

FIGS. 18-21 correspond to FIGS. 14-17, only showing a version of depth control arm 300 with the slide-type adjuster 310B from FIGS. 12-13. Similar to FIGS. 14-15, FIGS. 18-19 show the depth control arm 300 in its narrowest state, allowing the deepest penetration of the ground by tine assembly 22. FIG. 18 shows the tine assembly 22 in its fully raised position and FIG. 19 shows the tine assembly 22 in its fully lowered position. Like FIG. 15, the distance D1 of FIG. 19 represents the vertical distance that the tine assembly 22 moved downwardly to achieve its maximum depth when the adjustable depth control system 24 is in its maximum-depth state.

Similar to FIGS. 16-17, FIGS. 20-21 show the depth control arm in its widest state, restricting the tine assembly 22 to its shallowest penetration of the ground by tine assembly 22. Like in FIG. 17, the distance D2 represents the vertical distance that the tine assembly 22 moved downwardly to achieve its restricted maximum depth when the adjustable depth control system 24 is in its minimum-depth state.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

As indicated above, many changes and modifications may be made to the present invention without departing from the spirit thereof. The scope of some of these changes is discussed above. The scope of others is apparent from the appended claims.

What is claimed is:

1. An aerator comprising:
a chassis that includes a frame with a first support and a second support that are laterally spaced from each other;
an engine that is supported on the frame;
a tine assembly that is supported by the frame and that is configured to engage and aerate a ground surface; and
a drive system that is mounted to the frame and that is configured to receive power from the engine and to deliver power to the tine assembly, the drive system including a transmission that is supported by the chassis outwardly of a respective one of the pair of supports and that is configured to deliver power from the drive system to the tine assembly.

2. The aerator of claim 1, wherein:
the transmission is a first transmission of a pair of transmissions and is supported by the chassis outwardly of the first support and delivers power to a first side of the tine assembly;
a second transmission of the pair of transmissions is supported by the chassis outwardly of the second support and delivers power to a second side of the tine assembly.

3. The aerator of claim 2, wherein:
the tine assembly includes a first set of tines that is proximate the first support;
the first transmission delivers power to the first set of tines;
a second set of tines that is proximate the second frame rail; and
the second transmission delivers power to the second set of tines.

4. The aerator of claim 3, wherein:
the first and second sets of tines respectively define first and second sets of driven tines;
the tine assembly further includes:
a first set of undriven tines that are mounted inwardly of the first set of driven tines within the tine assembly;
a second set of undriven tines that are mounted inwardly of the second set of driven tines within the tine assembly.

5. The aerator of claim 4, wherein:
the first support is defined by a first frame rail;
the second support is defined by a second frame rail;
a first drive wheel is supported by the frame outwardly of the first frame rail and driven by the first transmission; and
a second drive wheel is supported by the frame outwardly of the second frame rail and driven by the second transmission.

6. The aerator of claim 5, wherein:
the first transmission includes:
a first drive motor that is configured to deliver power into the first transmission;
a first chain drive that is configured to transmit power from the first drive motor through the first transmission to each of the first set of driven tines and the first drive wheel;
a second drive motor that is configured to deliver power into the second transmission; and
a second chain drive that is configured to transmit power from the second drive motor through the second transmission to each of the second set of driven tines and the second drive wheel.

7. The aerator of claim 2, wherein:
the first support is defined by a first frame rail;
the second support is defined by a second frame rail;
the first transmission includes a first transmission cover that is connected to the first frame rail and has a side wall that is spaced outwardly from the first frame rail;
a first drive wheel is supported by the side wall of the first transmission cover;
the second transmission includes a transmission cover that is connected to the second frame rail and has a side wall that is spaced outwardly from the second frame rail; and
a second drive wheel is supported by the side wall of the second transmission cover.

8. The aerator of claim 2, wherein:
the drive system includes:
at least one hydraulic pump that receives power from to the engine to pressurize hydraulic fluid for by the drive system;
a first hydraulic motor that is hydraulically connected to the at least one hydraulic pump;
a second hydraulic motor that is hydraulically connected to the at least one hydraulic pump; and
wherein:
the first transmission connects and delivers power from the first hydraulic motor to a first set of tines within the tine assembly; and
the second transmission connects and delivers power from the second hydraulic motor to a second set of tines within the tine assembly.

9. An aerator comprising:
a chassis that includes a frame with a first frame rail and a second frame rail, wherein a distance between the first and second frame rails corresponds to a frame width dimension of the chassis;
a tine assembly that is supported by the frame between the first and second frame rails; and
a drive system that is mounted to the frame and that is configured to deliver power to the tine assembly, the drive system including:
a first drive motor that is supported by the frame with a first motor output shaft that extends outwardly beyond the first frame rail;
a second drive motor that is supported by the frame with a second motor output shaft that extends outwardly beyond the second frame rail;
a first drive wheel that is supported by the frame outwardly of the first frame rail;
a second drive wheel that is supported by the frame outwardly of the second frame rail;
a first transmission that is configured to transmit power from the first drive motor to the first drive wheel, wherein the first outboard transmission is supported by the frame laterally outside of the frame and between the first frame rail and the first drive wheel; and
a second transmission that is configured to transmit power from the second drive motor to the second drive wheel, wherein the second outboard transmission is supported by the frame laterally outside of the frame and between the second frame rail and the second drive wheel.

10. The aerator of claim 9, wherein:
the first transmission includes a first endless transmission device that is mounted outside of the first frame rail and drivingly connects the first drive motor to the first drive wheel;
the second transmission includes a second endless transmission device that is mounted outside of the second frame rail and drivingly connects the second drive motor to the second drive wheel.

11. The aerator of claim 10, wherein each of the first and second endless transmission devices includes a chain.

12. The aerator of claim 10, wherein:
the tine assembly include:
a first tine segment that is arranged toward the first frame rail;
a second tine segment that is configured to rotate independently of the first tine segment and that is arranged toward the second frame rail;
the first transmission delivers power to the first tine segment; and
the second transmission delivers power to the second tine segment.

13. The aerator of claim 12, wherein:
the first and second tines segments respectively define a first outer tine segment and a second outer tine segment, and
the tine assembly further comprises:
a pair of inner tine segments that are mounted between the first and second outer tine segments, the pair of inner tine segments including:
a first inner tine segment that is arranged inwardly of the first outer tine segment; and
a second inner tine segment that is arranged inwardly of the first segment.

14. The aerator of claim 13, wherein:
each of the first and second inner tine segments is configured to freewheel with respect to the corresponding first and second tines segments.

15. The aerator of claim 14, further comprising:
a first transmission cover that is mounted to and extends outwardly from the first frame rail, wherein the first drive wheel is mounted to the first transmission cover; and
a second transmission cover that is mounted to and extends outwardly from the second frame rail, wherein the second drive wheel is mounted to the second transmission cover.

16. An aerator comprising:
a chassis that includes a frame with a pair of frame rails that are laterally spaced from each other;
an engine that is mounted to the frame;
a tine assembly that includes multiple tines, wherein the tine assembly is configured to engage and aerate a ground surface with the tines;
a tine assembly support system that connects the tine assembly to the frame at a variable position with respect to the frame between a raised position and a lowered position, wherein a travel distance between the raised and lowered positions can be varied to provide an adjustable depth of the tine assembly; and
an adjustable depth control system that is configured to vary the travel distance between the raised and lowered positions of the tine assembly; where the adjustable depth control system comprises:
a depth control arm that includes:
an arm base that is mounted to and moves in unison with the tine assembly support system;
an adjuster that is mounted at a variable position to the arm base, wherein changing a position of the adjuster with respect to the arm base changes a maximum depth value of the tine assembly.

17. The aerator of claim 16, wherein:
the adjuster includes an adjuster plate in face-to-face engagement with the arm base;
a pair of guides is mounted to the arm base and guides movement of the adjuster plate with respect to the arm base during a depth adjustment procedure, wherein a width dimension of the depth control arm is changed by moving the adjuster plate with respect to the arm base during the depth adjustment procedure.

18. The aerator of claim 17, wherein:
the adjuster plate includes a slot;
the pair of guides includes a pair of guide pins that extend from a surface of the arm base and through the slot of the adjuster plate;
during the depth adjustment procedure, movement of the adjuster plate is guided by the slot sliding over the pair of guide pins while moving the position of the adjuster plate with respect to the arm base.

19. The aerator of claim 17, wherein:
the adjuster plate includes a slot;
the pair of guides includes:
a guide pin that extends from a surface of the arm base and through the slot of the adjuster plate;
a pivot pin that extends from the surface of the arm base and pivotally connects the adjuster plate to the arm base,
during the depth adjustment procedure, movement of the adjuster plate is guided by the slot sliding over the guide pin while moving the position of the adjuster plate with respect to the arm base by pivoting about the pivot pin.
